(19) United States
(12) Patent Application Publication
(10) Pub. No.: US 2015/0009667 A1
(43) Pub. Date: Jan. 8, 2015

(54) ILLUMINANT DEVICE

(71) Applicant: Lediamond Opto Corporation, New Taipei City (TW)

(72) Inventors: Peng-Yu CHEN, New Taipei City (TW); Chung-Ting TSENG, New Taipei City (TW)

(21) Appl. No.: 14/310,558

(22) Filed: Jun. 20, 2014

(30) Foreign Application Priority Data
Jul. 8, 2013 (TW) 102124394

(51) Int. Cl. F21V 29/00; F21K 99/00

(52) U.S. Cl. CPC F21V 29/22; F21K 9/30; F21K 9/56
USPC 362/237; 362/249.02

(57) ABSTRACT

An illuminant device includes a lighting module and a first transparent heat-dissipating component. The lighting module includes a transparent substrate, a circuit layer, a plurality of light emitting diode (LED) dies, a first transparent resin layer, and a second transparent resin layer. The transparent substrate includes a first surface and a second surface opposite to the first surface. The circuit layer is placed on the first surface. The LED dies are placed on the first surface and electrically connected to the circuit layer. The first transparent resin layer is disposed on the first surface and covers the light emitting diode dies. The second transparent resin layer is disposed on the second surface and corresponding to the first transparent resin layer. The first transparent heat-dissipating component is arranged on the first transparent resin layer and opposite to the transparent substrate.

### BACKGROUND OF THE INVENTION

1. Field of the Invention

The present invention relates to an illuminant device, and in particular to an light emitting diode (LED) illuminant device with transparent heat-dissipating component.

2. Description of Related Art

A light emitting diode (LED) is a kind of semiconductor device, which exploits the property of direct-bandgap semiconductor material to convert electric energy into light energy efficiently and has the advantages of long service time, high stability and low power consumption and is developed to replace the traditional non-directivity light tube and incandescent lamp.

However, in comparison to other lighting source, LEDs with higher power are more prone to a problem of heat dissipation. The main reason is that the heat of the LEDs cannot be dissipated through infrared radiation. In general, over-temperature operation makes the LEDs to have reduced light output (light decay) and color shift and accelerates aging to shorten the lifetime of the LEDs.

In order to solve the problems mentioned above, some manufacturers dispose opaque heat-dissipating component, such as heat-dissipating fins, for conducting heat generated by the LEDs. However, the opaque heat-dissipating component inevitably shields light emitted from the LEDs to reduce light usage efficiency of the LED light module.

### SUMMARY OF THE INVENTION

It is an object to provide an illuminant device having transparent heat-dissipating component to conduct heat generated from operating illuminant device, and having advantaged of high usage efficiency.

Accordingly, the illuminant device according to one aspect of the present invention comprises a lighting module and a first transparent heat-dissipating component. The lighting module comprises a transparent substrate, a circuit layer, a plurality of light emitting diode (LED) dies, a first transparent resin layer, and a second transparent resin layer. The transparent substrate comprises a first surface and a second surface opposite to the first surface. The circuit layer is placed on the first surface. The LED dies are placed on the first surface and electrically connected to the circuit layer. The first transparent resin layer is disposed on the first surface and covers the LED dies. The second transparent resin layer is disposed on the second surface. The first transparent heat-dissipating component is arranged on the first transparent resin and opposite to the transparent substrate.

In an embodiment of the present invention, a thermal conductivity of the first transparent heat-dissipating component is higher than 0.2 W/mK. Moreover, the first transparent heat-dissipating component comprises a first plane. The area of the first plane is larger than that of the first surface, so that the first transparent heat-dissipating component can effectively conduct heat generated by the lighting module. The second transparent heat-dissipating component comprises a second plane. The area of the second plane is larger than that of the second surface, so that the second transparent heat-dissipating component can effectively conduct heat generated by the lighting module. In an embodiment of the present invention, the illuminant device further comprises a second transparent heat-dissipating component arranged on the second transparent resin layer and opposite to the transparent substrate.

In an embodiment of the present invention, a thermal conductivity of the second transparent heat-dissipating component is higher than 0.2 W/mK.

In an embodiment of the present invention, the first transparent heat-dissipating component is composed of a plurality of heat-dissipating blocks.

In an embodiment of the present invention, the heat-dissipating blocks are arranged with an interval, so that heat can be rapidly conducted from the illuminant device.

In an embodiment of the present invention, a phosphor is disposed within the first transparent resin layer and the second transparent resin layer.

In an embodiment of the present invention, the illuminant device further comprises a first phosphor layer and a second phosphor layer, the first phosphor layer is disposed on the first transparent heat-dissipating component and opposite to the first transparent resin layer, the second phosphor layer is disposed on the second transparent heat-dissipating component and opposite to the second transparent resin layer.

In an embodiment of the present invention, the first transparent heat-dissipating component comprises a first plane, an area of the first plane is larger than an area of the first surface.

In an embodiment of the present invention, the second heat-dissipating component comprises a second plane, an area of the second plane is larger than an area of the second surface.

In an embodiment of the present invention, the first transparent heat-dissipating component comprises a first recess, the second transparent heat-dissipating component comprises a second recess, the first transparent heat-dissipating component is assembled with the second transparent heat-dissipating component such that the first recess and the second recess collectively define an accommodating space for accommodating the lighting module.

The first transparent heat-dissipating component can effectively conduct heat generated by the lighting module, so that service time of the lighting module can be extended, and phenomena of luminous decay and color shifting can be prevented to increase light use efficiency.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective view of an illuminant device according to a first embodiment of the present invention.

FIG. 2 is a sectional view of the illuminant device according to the first embodiment of the present invention.

FIG. 3 is a perspective view of a lighting module according to a first embodiment of the present invention.

FIG. 4 is a sectional view of the lighting module according to the first embodiment of the present invention.

FIG. 5 is a perspective view of an illuminant device according to a second embodiment of the present invention.

FIG. 6 is a sectional view of the illuminant device according to the second embodiment of the present invention.

FIG. 7 is a sectional view of an illuminant device according to a third embodiment of the present invention.

FIG. 8 is a perspective view of an illuminant device according to a forth embodiment of the present invention.

FIG. 9 is a sectional view of the illuminant device according to the forth embodiment of the present invention.

FIG. 10 is a sectional view of an illuminant device according to a fifth embodiment of the present invention.

### DETAILED DESCRIPTION OF THE INVENTION

A preferred embodiment of the present invention will be described with reference to the drawings.

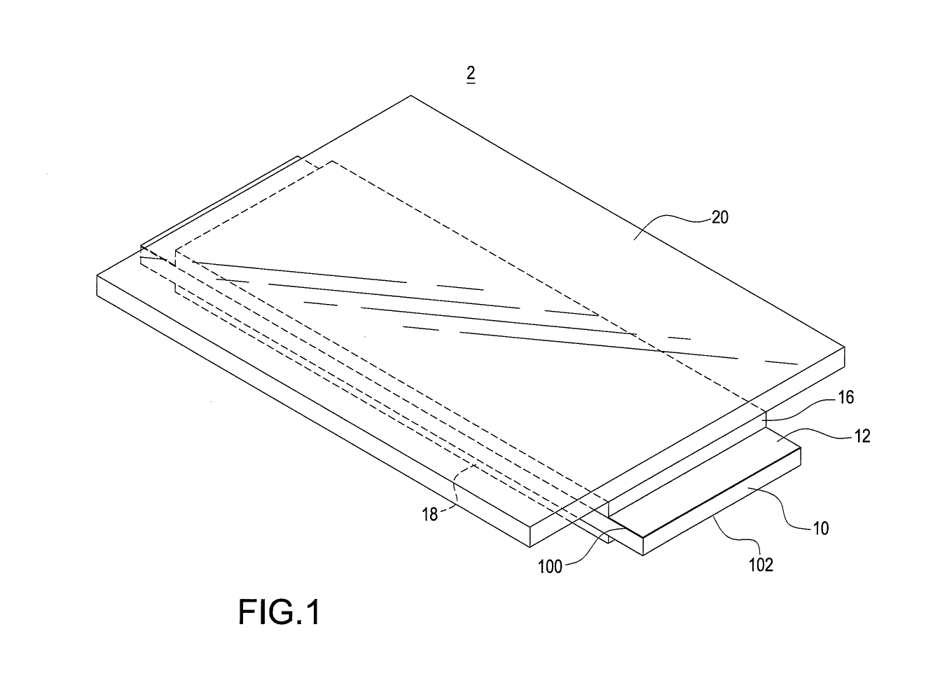

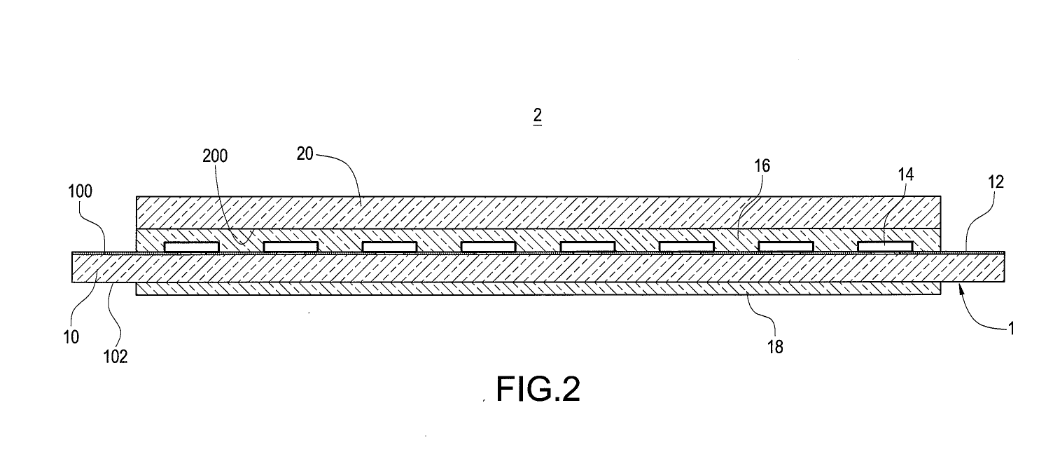

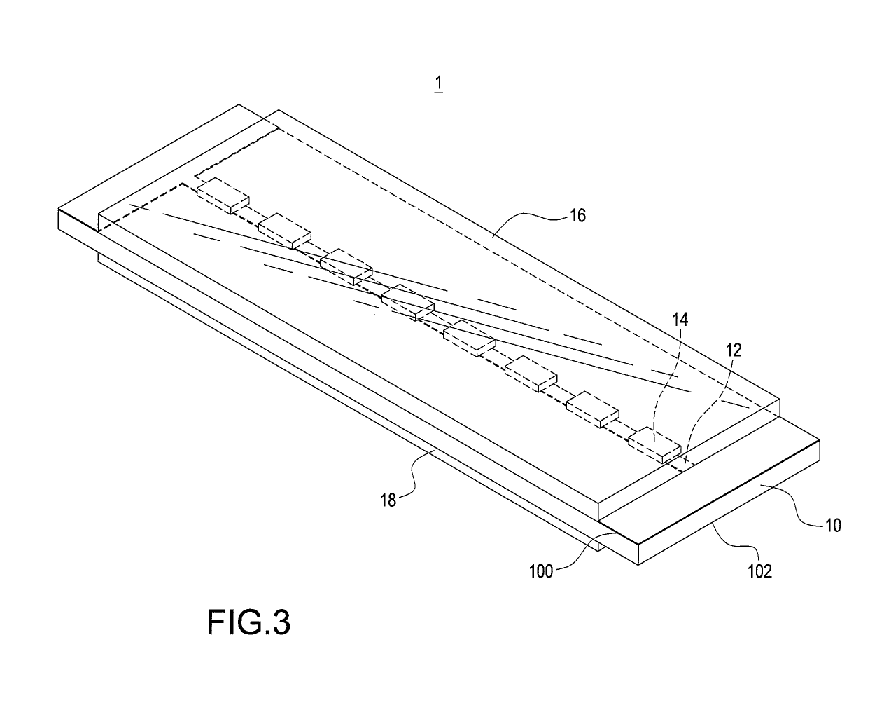

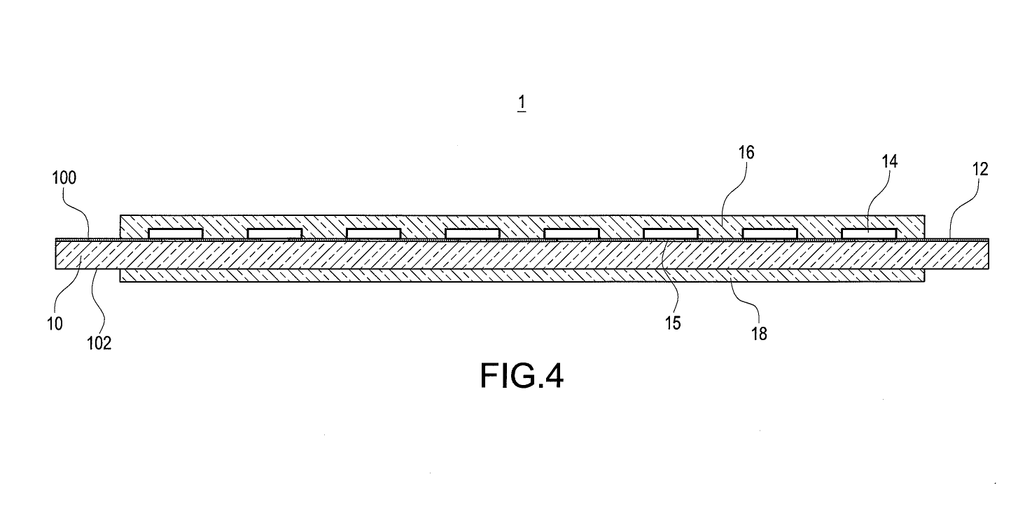

Reference is made to FIG. 1 and FIG. 2, which are respectively a perspective view and a sectional view of an illuminant device according to a first embodiment of the present invention. The illuminant device 2 includes a lighting module 1 (as shown in FIG. 3 and FIG. 4) and a first transparent heat-dissipating component 20. The lighting module 1 includes a transparent substrate 10, a circuit layer 12, a plurality of light emitting diode (LED) dies 14, a first transparent resin layer 16, and a second transparent resin layer 18. The transparent substrate 10 includes a first surface 100 and a second surface 102 opposite to the first surface 100. The transparent substrate 10 is, for example, made of quartz or glass allowing light emitted from the LED dies 14 transmitting therethrough. In this embodiment, a profile of the transparent substrate 10 is rectangular, and the first surface 100 and the second surface 102 are two planes having larger area on two opposite faces of the transparent substrate 10.

The circuit layer 12 is placed on the first surface 100. The circuit layer 12 is, for example, made of copper or other material with electrical conductivity for conducting electric power. The LED dies 14 are placed on the first surface 100 and electrically connected to the circuit layer 12. In this embodiment, the LED dies 14 are arranged in a linear manner and spaced with an interval, and electrically connected in series via the circuit layer 12. In the practical application, the LED dies 14 can arrange in a matrix manner or an irregular manner, and electrically connected in parallel or series-parallel via the circuit layer 12. The LED dis 14 is placed on the first surface 100 by die attachment technology, and then electrically connected to the circuit layer 12. In this embodiment, the LED dies 14 is flip chip structure LED dies, therefore two electrodes (not shown) of each LED die 14 are directly connected to the circuit layer 12. In the practical application, the LED dies 14 can be horizontal structure LED dies and electrodes of each LED die 14 are electrically connected to the circuit layer 12 via two wires, respectively. The LED dies 14 also can be perpendicular structure LED dies and one electrode of each LED die 14 is directly connected to the circuit layer 12, and the other electrode of the LED die 14 is electrically connected to the circuit layer 12 via a wire.

The first transparent resin layer 16 is disposed on the first surface 100 and covers the LED dies 14. In this embodiment, the first transparent resin layer 16 not only covers the LED dies 14, but partially covers the first surface 100 and fill in gaps 15 collectively define by the circuit layer 12, the LED dies 14 and the first surface 100, therefore the LED dies 14 can be fixedly placed on the first surface 100. A profile of first transparent resin layer 16 is substantially rectangular, and an area of the first transparent resin layer 16 disposed on the first surface 100 is smaller than an area of the first surface 100. The first transparent resin layer 16 is, for example, made of epoxy or silicone resin, allowing light emitted from the LED dies 14 passing therethrough. The first transparent resin layer 16 is used for protecting the LED dies 14.

The second transparent resin layer 18 is disposed on the second surface 102, and an area of the second transparent resin layer 18 disposed on the second surface 102 is the same as the area of the first transparent resin layer 16 disposed on the first surface 100. The second transparent resin layer 18 is used for protecting the transparent substrate 10 and uniforming light emitted from the LED dies 14. The second transparent resin layer 18 is, for example, made of epoxy or silicone resin, allowing light emitted from the LED die 14 passing therethrough.

With referrer again to FIG. 1 and FIG. 2, the first transparent heat-dissipating component 20 is arranged on the first transparent resin layer 16 and opposite to the transparent substrate 10 for conducting heat generated by operating lighting module 1. The first transparent heat-dissipating component 20, made of quartz or glass for example, allows light emitted from the LED dies 14 passing therethrough and prevents light emitted from the LED dies 14 from shielding (namely, to increase light usage efficiency). In this embodiment, the first transparent heat-dissipating component 20 is a rectangular plate and includes a first plane 200. The first plane 200 is a plane having larger area of the first transparent heat-dissipating component 20. An area of the first plane 200 is larger than the area of the first surface 100, which can rapidly conduct heat generated by operating lighting module 1. A thermal conductivity of the first transparent heat-dissipating component 20 is larger than 0.2 W/mK.

To sum up, the first transparent heat-dissipating component 20 according to the present invention is made of transparent material such that the first transparent heat-dissipating component 20 not only conducts heat generated from the LED dies 14 to lengthen lifetime of LED dies 14 and prevent light decay and color shift, but also prevents light emitted from the LED dies 14 from shielding and enhance light usage efficiency. Besides, light emitted from the LED dies 14 not only transmits to a direction toward the first transparent resin layer 16, but also transmits to a direction toward the second transparent resin layer 18 by passing through the first surface 100 and the second surface 102. In additions, the first transparent resin layer 16 and the second transparent resin layer 18 are transparent and allows light passing therethrough such that an illuminant angle of the illuminant device 2 can be effectively increased.

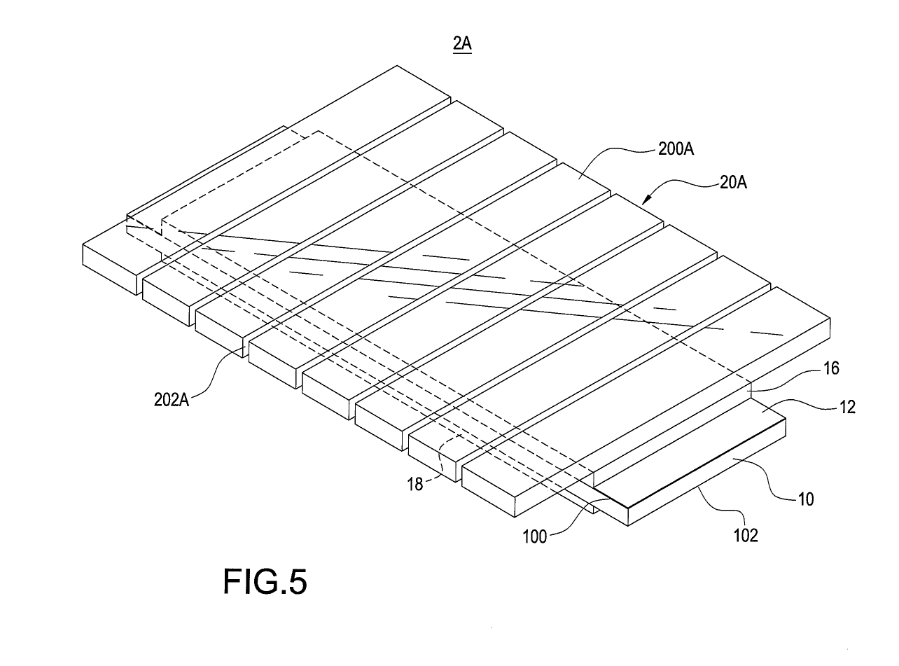

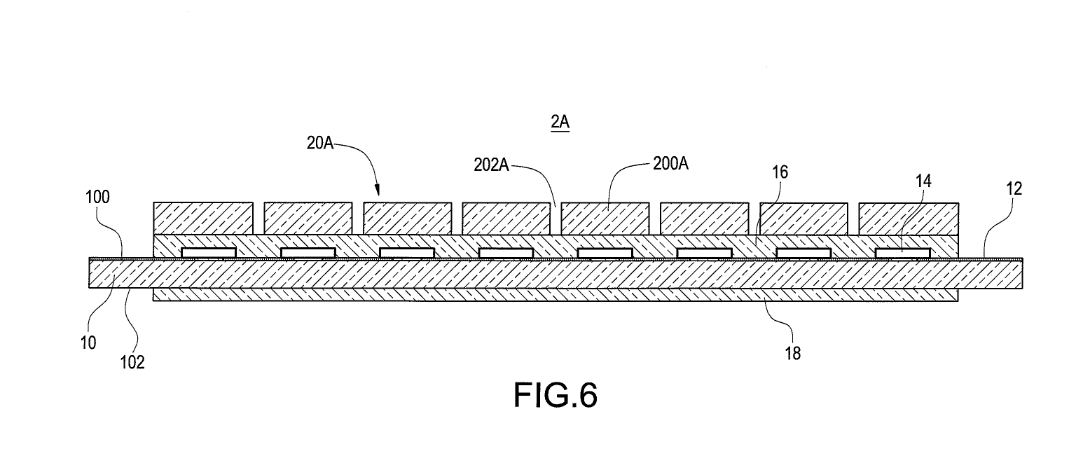

Reference is made to FIG. 5 and FIG. 6, which are respectively a perspective view and a sectional view of an illuminant device according to a second embodiment of the present invention. The illuminant device 2A is similar to the illuminant device 2 mentioned in the first embodiment, and the same reference numbers are used in the drawings and the description to refer to the same parts. It should be noted that the first transparent heat-dissipating component 20A of the illuminant device 2A shown in FIG. 5 and FIG. 6 is composed of a plurality of heat-dissipating blocks 200A.

The heat-dissipating blocks 200A are arranged on the first transparent resin layer 16 and opposite to the transparent substrate 10. In this embodiment, the heat-dissipating blocks 200A are arranged with intervals, and then a plurality of passageways 202A are formed with intervals. The passageways 202A allows air flowing therethrough such that heat generated by the LED dies 14 can be rapidly conducted away from the illuminant device 2A by heat convection, and lifetime of the illuminant device 2A can be further increased. In the practical application, the heat-dissipating blocks 200A can be arranged in a matrix manner or an irregular manner. The function and relative description of other components of the illuminant device 2A are the same as that of first embodiment mentioned above and are not repeated here for brevity, and the illuminant device 2A can achieve the functions as the illuminant device 2 does.

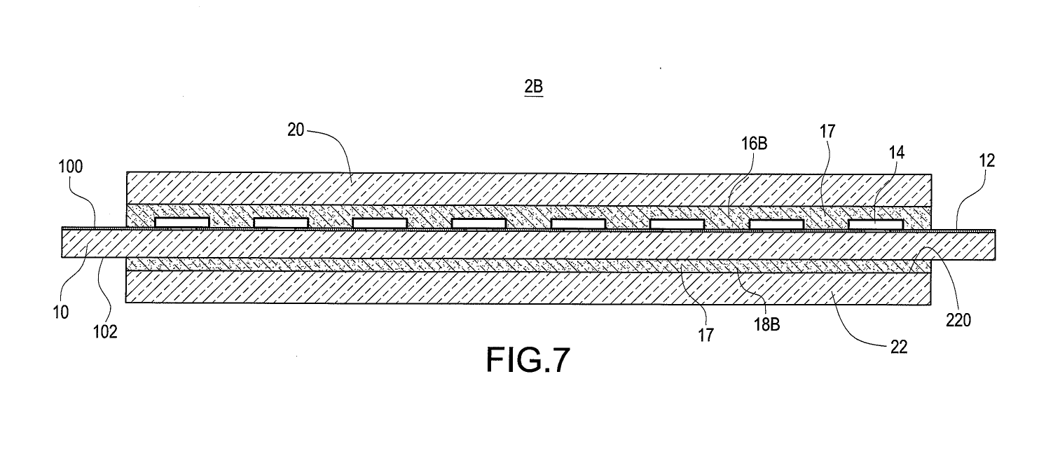

Reference is made to FIG. 7, which is a sectional view of an illuminant device according to a third embodiment of the present invention. The illuminant device 2B is similar to the illuminant device 2 mentioned in the first embodiment, and the same reference numbers are used in the drawings and the description to refer to the same parts. It should be noted that the illuminant device 2B further includes a second transparent heat-dissipating component 22.

The transparent heat-dissipating component 22 is arranged on the second transparent resin layer 18B for conducting heat generating by the lighting module 1. The second transparent heat-dissipating component 22 is, for example, made of quartz or glass, and can prevent light emitted from the LED dies 14 from shielding, and then enhance light usage efficiency. In this embodiment, the second transparent heat-dissipating component 22 is a rectangular plate, and a dimension of the second transparent heat-dissipating component 22 is the same as a dimension of the first transparent heat-dissipating component 20. However, in the practical application, the dimension of the second transparent heat-dissipating component 22 can be different from the dimension of the first transparent heat-dissipating component 20. The second transparent heat-dissipating component 22 includes a second plane 220. The second plane 220 is a plane having larger area of the second transparent heat-dissipating component 22. An area of the second plane 220 is larger than an area of the second surface 102 for rapidly conducting heat generated by the lighting module 1. A thermal conductivity of the second transparent heat-dissipating component 22 is larger than 0.2 W/mK.

Besides, a phosphor 17 is disposed within the first transparent resin layer 16B and the second transparent resin layer 18B. The phosphor 17 is excited by partial light emitted from the LED dies 14 and then converts the light into a wavelength-converted light, which is to be mixed with the other light emitted from the LED dies 14 to generate a light with demand color. The function and relative description of other components of the illuminant device 2B are the same as that of first embodiment mentioned above and are not repeated here for brevity, and the illuminant device 2B can achieve the functions as the illuminant device 2 does.

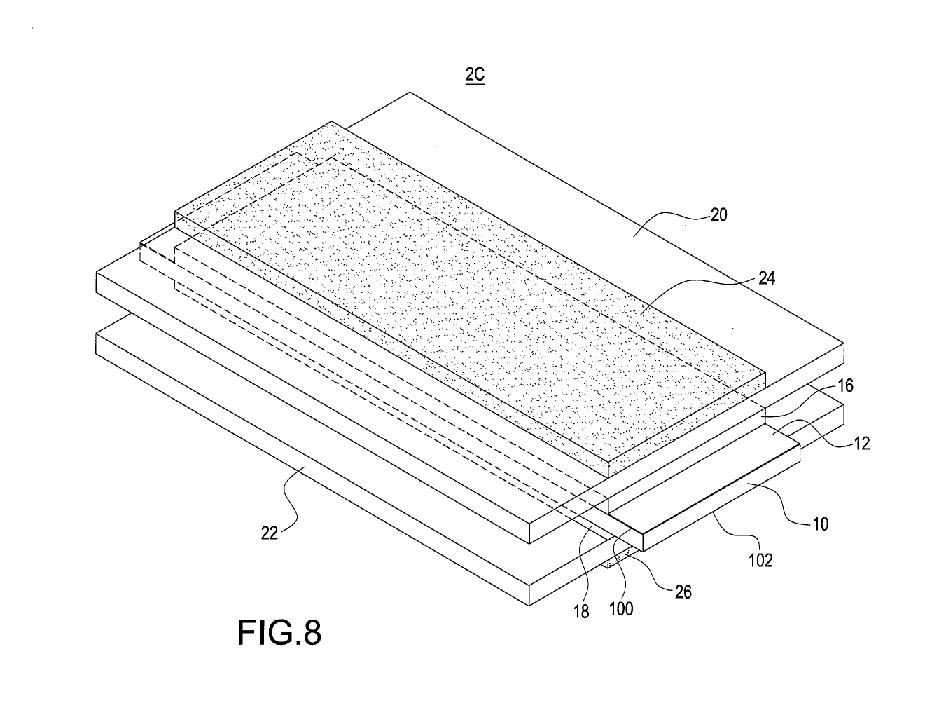

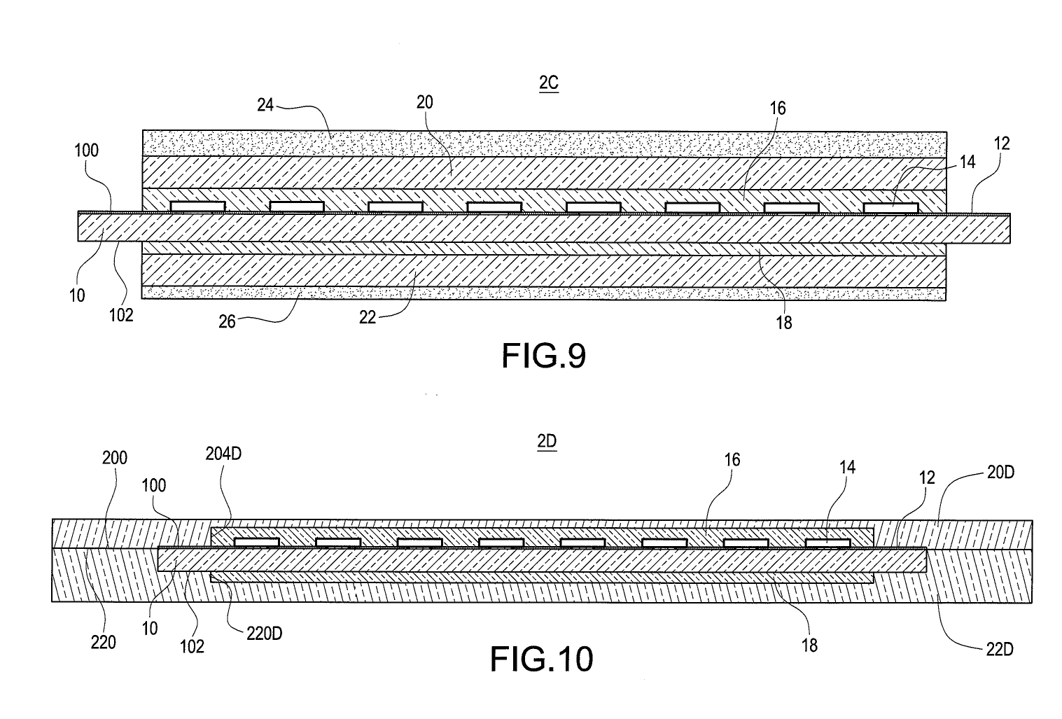

Reference is made to FIG. 8 and FIG. 9, which are respectively a perspective view and a sectional view of an illuminant device according to a forth embodiment of the present invention. The illuminant device 2C is similar to the illuminant device 2B mentioned in the third embodiment, and the same reference numbers are used in the drawings and the description to refer to the same parts. It should be noted that the illuminant device 2C further includes a first phosphor layer 24 and a second phosphor layer 26.

The first phosphor layer 24 is disposed on the first transparent heat-dissipating component 20 and opposite to the first transparent resin layer 16. The first phosphor layer 24 is mixed with transparent resin and phosphor, and is excited by partial light emitted from the LED dies 14 and then converts the light into a first wavelength-converted light, which is to be mixed with the other light emitted from the LED dies 14 to generate a light with demand color. In this embodiment, an area of the first phosphor layer 24 disposed on the first transparent heat-dissipating component 20 is the same as the area of the first transparent resin layer 16 disposed on the first surface 100.

The second phosphor layer 26 is disposed on the second transparent heat-dissipating component 22 and opposite to the second transparent resin layer 18. The second phosphor layer 26 is mixed with transparent resin and phosphor, and is excited by partial light emitted from the LED dies 14 and then converts the light into a second wavelength-converted light, which is to be mixed with the other light emitted from the LED dies 14 to generate a light with demand color. In this embodiment, an area of the second phosphor layer 26 disposed on the second transparent heat-dissipating component 22 is the same as the area of the first phosphor layer 24 disposed on the first transparent heat-dissipating component 20, and is the same as the area of the second transparent resin layer 18 disposed on the second surface 102. Besides, the first wavelength-converted light can be same as the second wavelength-converted light. However, the first wavelength-converted light can be different from the second wavelength-converted light. Furthermore, a thickness of the first phosphor layer 24 can be the same as a thickness of the second phosphor layer 26. However, the thickness of the first phosphor layer 24 can be different from the thickness of the second phosphor layer 26. In particularly, the thickness of the first phosphor layer 24 is equal to a distance located between a surface of the first phosphor layer 24 in contacted with the first transparent heat-dissipating component 20 and a surface opposite to the surface mentioned above.

It should be noted that instead of disposing phosphor within the first transparent resin layer 16 and the second transparent resin layer 18, the illuminant device 2C deposed the first phosphor layer 24 and the second phosphor layer 26 on the first transparent heat-dissipating component 20 and the second transparent heat-dissipating component 22, respectively. The function and relative description of other components of the illuminant device 2C are the same as that of third embodiment mentioned above and are not repeated here for brevity, and the illuminant device 2C can achieve the functions as the illuminant device 2B does.

Reference is made to FIG. 10, which is a sectional view of an illuminant device according to a fifth embodiment of the present invention. The illuminant device 2D is similar to the illuminant device 2B mentioned in the third embodiment, and the same reference numbers are used in the drawings and the description to refer to the same parts. It should be noted that the first heat-dissipating component 20D shown in FIG. 10 further includes a first recess 204D, and the second heat-dissipating component 22D further includes a second recess 220D.

The first plane 200 of the first transparent heat-dissipating component 20D is in contacted with the second plane 220 of the second transparent heat-dissipating component 22D while the first transparent heat-dissipating component 20D is assembled with the second transparent heat-dissipating component 22D, such that the first recess 204D and the second recess 220D are collectively defined an accommodating space for accommodating the lighting module 1 and protecting the lighting module 1.

It should be noted that the first transparent resin layer 16 and the second transparent resin layer 18 are not disposed with phosphor. However, in the practical application, phosphor can be disposed within the first transparent resin layer 16 and the second transparent layer 18. The function and relative description of other components of the illuminant device 2D are the same as that of third embodiment mentioned above and are not repeated here for brevity, and the illuminant device 2D can achieve the functions as the illuminant device 2B does.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An illuminant device comprising:
a lighting module comprising:
a transparent substrate comprising a first surface and a second surface opposite to the first surface;
a circuit layer placed on the first surface;
a plurality of light emitting diode (LED) dies placed on the first surface and electrically connected to the circuit layer;
a first transparent resin layer disposed on the first surface and covering the LED dies; and
a second transparent resin layer disposed on the second surface; and
a first transparent heat-dissipating component arranged on the first transparent resin and opposite to the transparent substrate.

2. The illuminant device in claim 1, wherein a thermal conductivity of the first transparent heat-dissipating component is higher than 0.2 W/mK.

3. The illuminant device in claim 2, further comprising a second transparent heat-dissipating component arranged on the second transparent resin layer and opposite to the transparent substrate.

4. The illuminant device in claim 3, wherein a thermal conductivity of the second transparent heat-dissipating component is higher than 0.2 W/mK.

5. The illuminant device in claim 1, wherein the first transparent heat-dissipating component is composed of a plurality of heat-dissipating blocks.

6. The illuminant device in claim 5, wherein the heat-dissipating blocks are arranged with an interval.

7. The illuminant device in claim 1, wherein a phosphor is disposed within the first transparent resin layer and the second transparent resin layer.

8. The illuminant device in claim 3, further comprising:
a first phosphor layer disposed on the first transparent heat-dissipating component and opposite to the first transparent resin layer; and
a second phosphor layer disposed on the second transparent heat-dissipating component and opposite to the second transparent resin layer.

9. The illuminant device in claim 1, wherein the first transparent heat-dissipating component comprises a first plane, an area of the first plane is larger than an area of the first surface.

10. The illuminant device in claim 3, wherein the second heat-dissipating component comprises a second plane, an area of the second plane is larger than an area of the second surface.

11. The illuminant device in claim 3, wherein the first transparent heat-dissipating component comprises a first recess, the second transparent heat-dissipating component comprises a second recess, the first transparent heat-dissipating component is assembled with the second transparent heat-dissipating component such that the first recess and the second recess collectively define an accommodating space for accommodating the lighting module.
